(19) United States
(12) Patent Application Publication
(10) Pub. No.: US 2015/0083085 A1
(43) Pub. Date: Mar. 26, 2015

(54) FUEL INJECTION SYSTEM FOR AN INTERNAL COMBUSTION ENGINE

(71) Applicant: Robert Bosch GmbH, Stuttgart (DE)

(72) Inventors: Paul Bartholomew Ravenhill, Norfolk (GB); Richard Matthew Hoolahan, Norfolk (GB)

(21) Appl. No.: 14/558,051

(22) Filed: Dec. 2, 2014

Related U.S. Application Data
(63) Continuation of application No. 12/678,034, filed on Mar. 12, 2010.

(51) Int. Cl. F02D 7/00; F02D 15/04; F02D 9/08

(52) U.S. Cl. CPC F02D 7/002; F02D 9/08; F02D 15/04
USPC 123/48 R

(57) ABSTRACT

With reference to FIG. 1, the present invention provides an internal combustion engine comprising a variable volume combustion chamber (10), an air intake passage (18), a throttle (23), a bypass passage (28) which bypasses the throttle (23) and via which air and/or recirculated exhaust gas is supplied to the intake passage (18) via a delivery nozzle (27) located downstream of the throttle (23). A fuel injector (20) delivers fuel to a mixing chamber and the bypass passage (28) is connected to the mixing chamber so that air or recirculated exhaust gas flowing through the bypass chamber entrains fuel present in the mixing chamber and a resulting mixture is delivered to the intake passage (18) via the delivery nozzle (28).

The present invention relates to a fuel injection system for an internal combustion engine. The system is particularly suited for use with small capacity engines such as used in garden equipment, e.g. lawnmowers.

In GB 2421543 the applicant has described a “pulse count” injection system in which the quantity of fuel delivered to a combustion chamber in each engine cycle is controlled by controlling the number of operations of an injector which delivers in each operation a set quantity of fuel. Most commonly available systems operate with pulse width modulation (PWM) which controls the opening period of an injector to control the quantity of fuel delivered, with a need for a high pressure fuel supply to the injector and a pressure regulator to ensure that variations in pressure to the inlet manifold do not affect the quantity of fuel delivered. The apparatus of GB 2421543 avoided this by the injector itself operating as a pump and delivering a set quantity of fuel regardless of changes in pressure in the inlet manifold; then the total amount of fuel becomes a function of the number of times the injector is operated.

In UK application No. 0522068.6, a development of the system of GB 2421543 was described. In this a sonic nozzle was incorporated so that fuel delivered by the pulse count injector is entrained in air (or combusted gases) to be delivered to the inlet manifold via a sonic nozzle in which the gas flow reached or approached the speed of sound. This resulted in better atomisation of the delivered fuel.

The present invention in a first aspect provides an internal combustion engine as claimed in claim 1.

The present invention in a second aspect provides an internal combustion engine as claimed in claim 3.

The present invention provides an alternative method of atomisation of the fuel delivered by the fuel injector. The use of fuel and air mixing means has been found surprisingly to achieve better atomisation and fuel delivery than a sonic nozzle. Also, the new design allows the use of the arrangement to deliver fuel downwardly into an inlet manifold, rather than just upwardly.

Preferred embodiments of the present invention will now be described with reference to the accompanying drawings, in which:

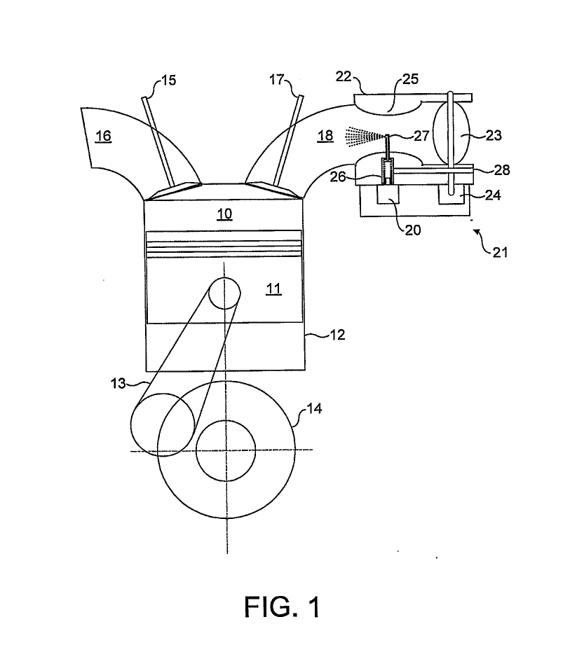

FIG. 1 is a schematic illustration of an internal combustion engine having a first embodiment of fuel injection system according to the present invention;

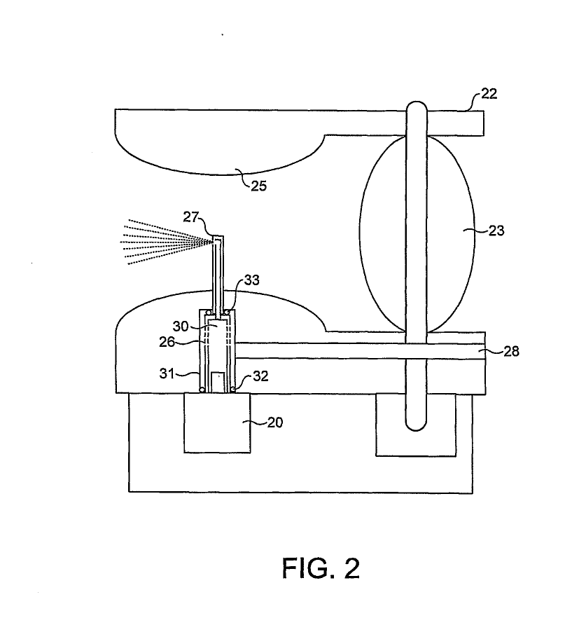

FIG. 2 is an illustration of the throttle body of the fuel injection system of FIG. 1, showing in greater detail a mixing tube, pulse count injector and by-pass inlet passage;

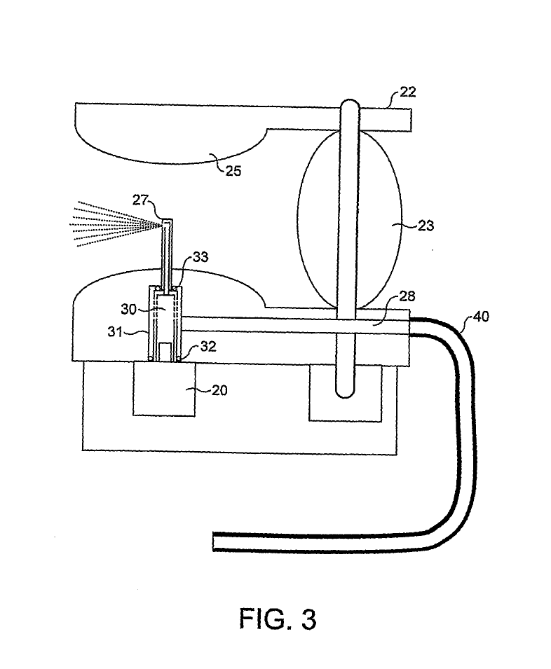

FIG. 3 shows a variant of the FIG. 2 embodiment, in which the by-pass inlet passage is connected to receive recirculated combusted gases rather than air;

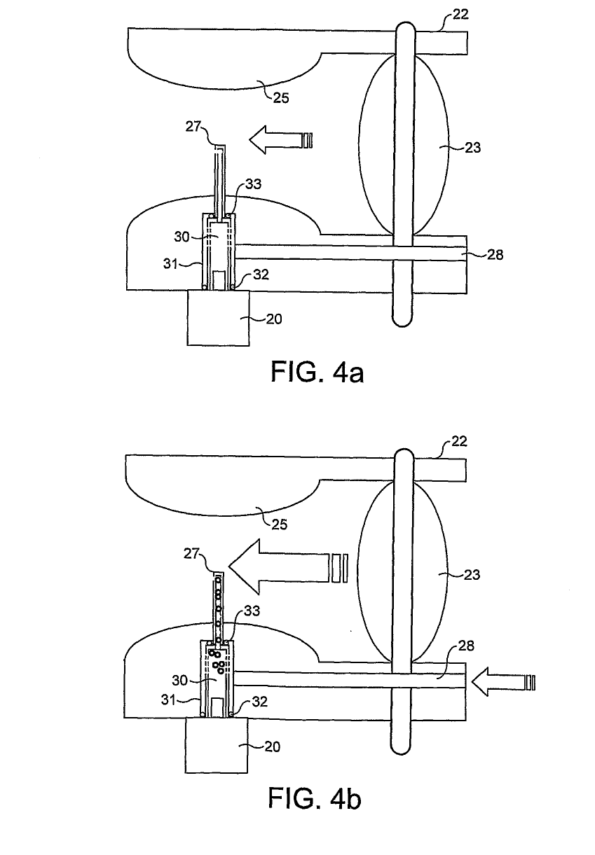

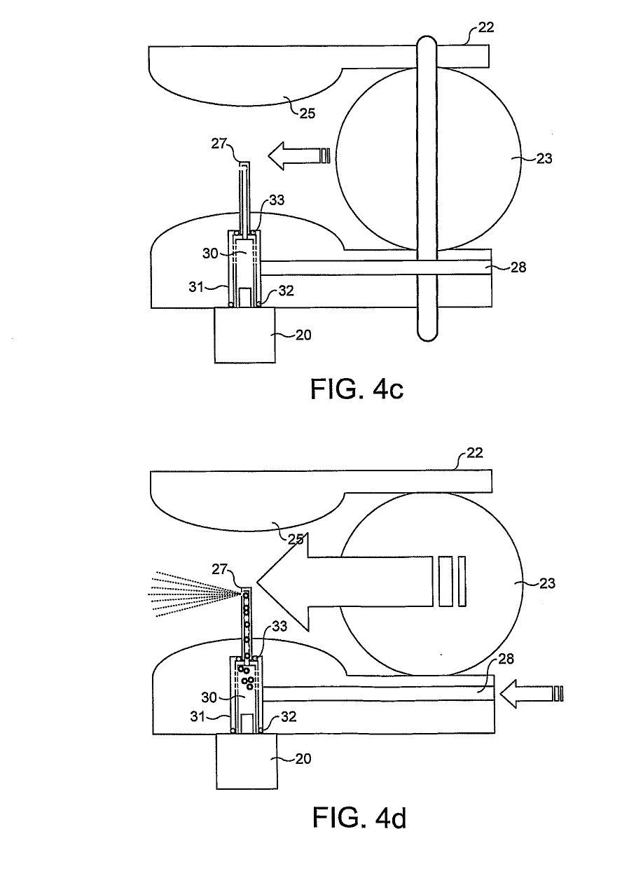

FIGS. 4a to 4d show operation of the FIG. 2 fuel injection system during a single engine cycle;

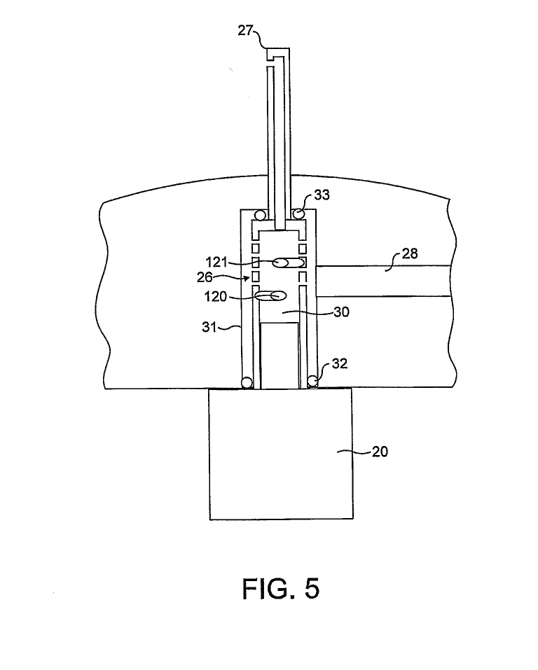

FIG. 5 is a view in greater detail of the mixing tube used in the fuel injection systems of FIGS. 2 and 3;

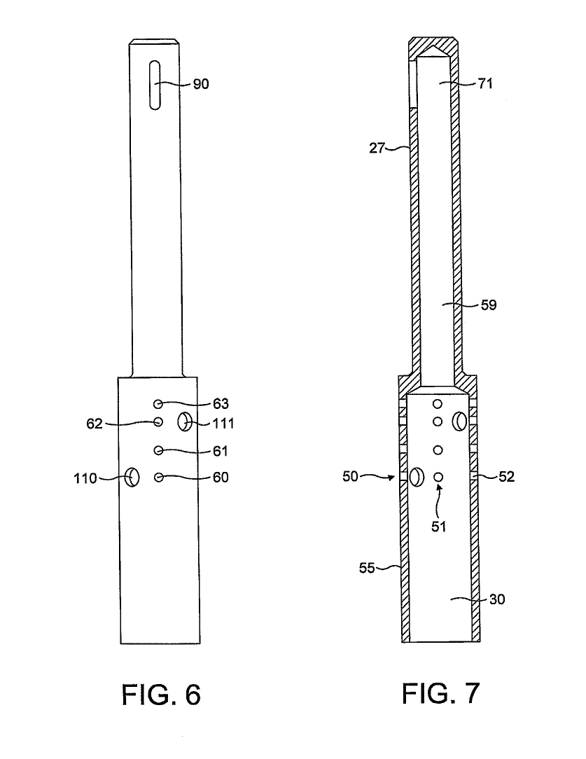

FIG. 6 is a side elevation view of the mixing tube of FIG. 5;

FIG. 7 is a cross-section through the mixing tube of FIG. 6;

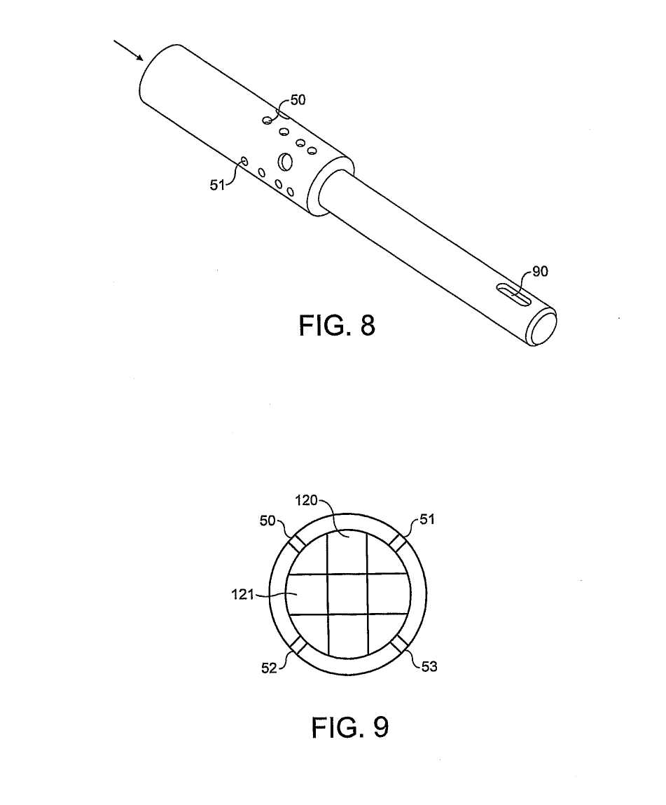

FIG. 8 is an isometric view of the mixing tube of FIGS. 5, 6 and 7;

FIG. 9 is an end view of the mixing tube of FIGS. 5 to 8,

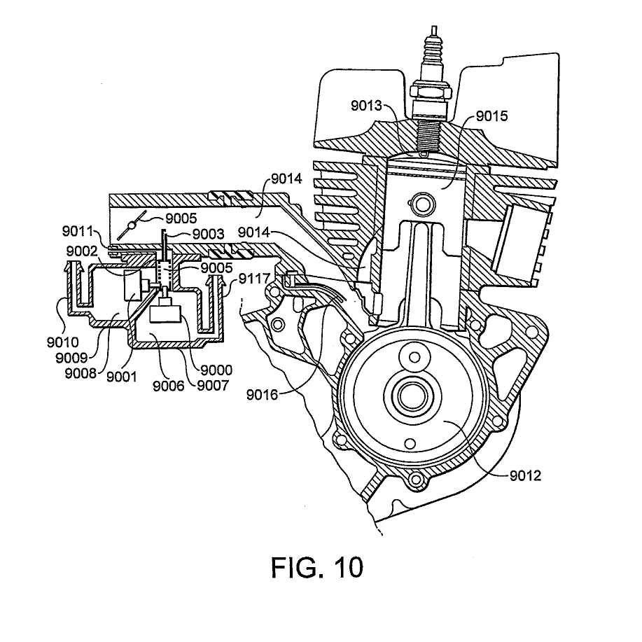

FIG. 10 shows a two-stroke internal combustion engine having a second embodiment of fuel injection system according to the present invention;

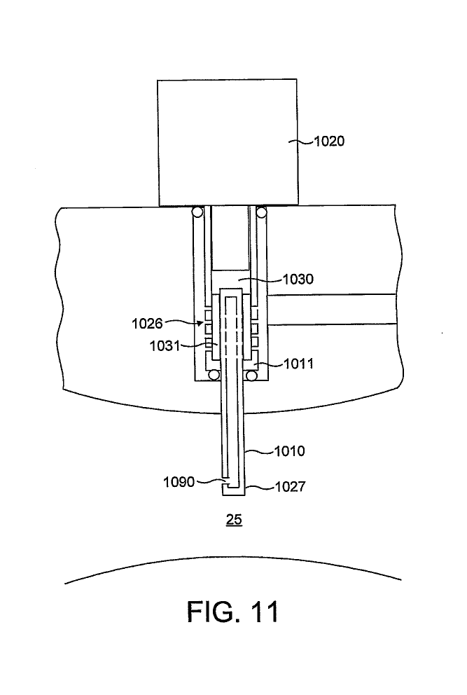

FIG. 11 is a schematic view of a second type of mixing tube suitable for use in fuel injection systems according to the present invention;

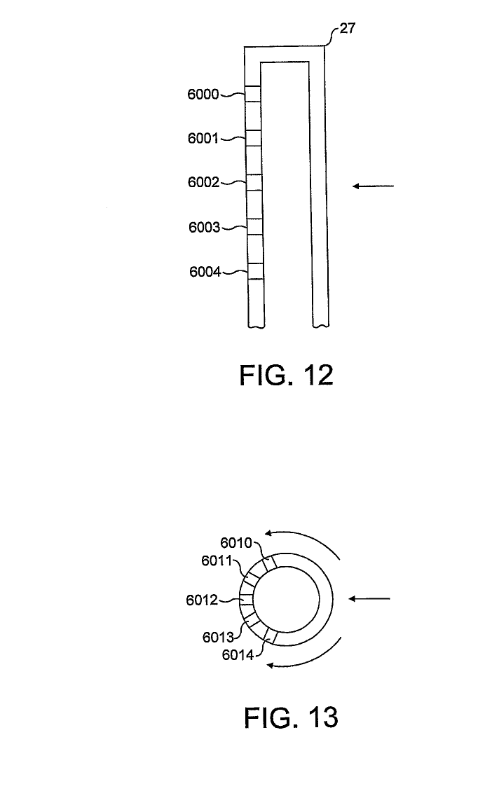

FIG. 12 is a cross-sectional view taken along a fuel delivery nozzle suitable for the fuel injector systems of FIGS. 1 to 4d;

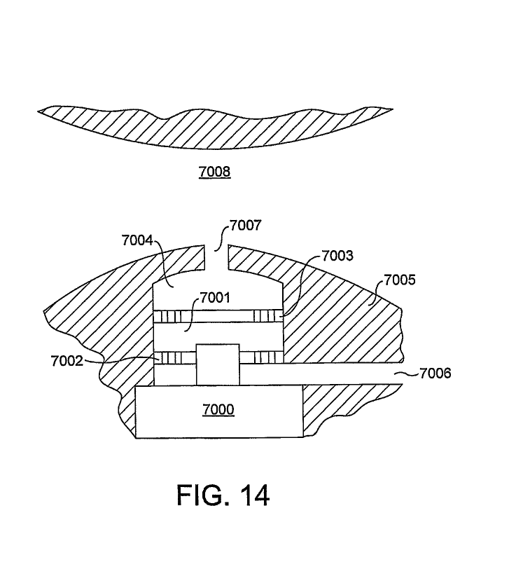

FIG. 13 is a cross-sectional view across the FIG. 14 fuel delivery nozzle;

FIG. 14 is an illustration of mixing apparatus comprising a perforated plate;

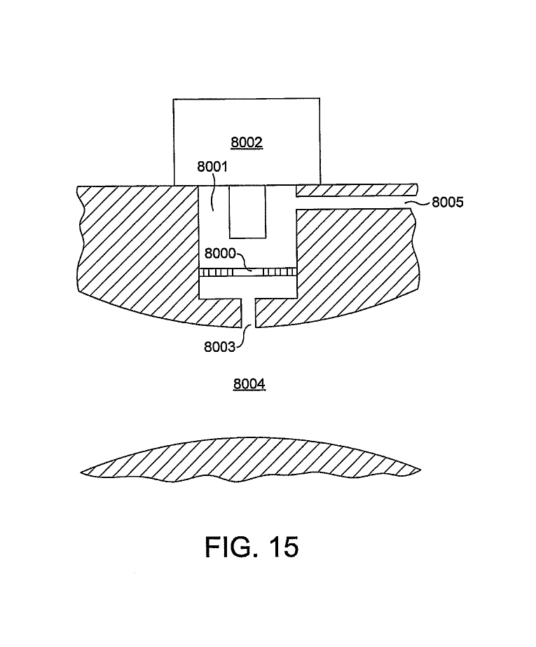

FIG. 15 is an illustration of mixing apparatus for a downwardly directing injector, comprising a plurality of perforated plates;

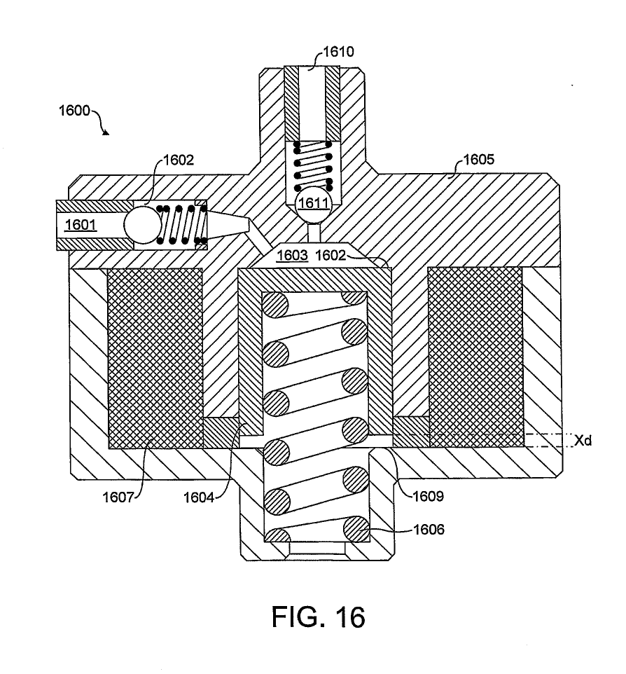

FIG. 16 shows a cross-section through a fuel injector suitable for use in the fuel injection system of FIGS. 1 and 10;

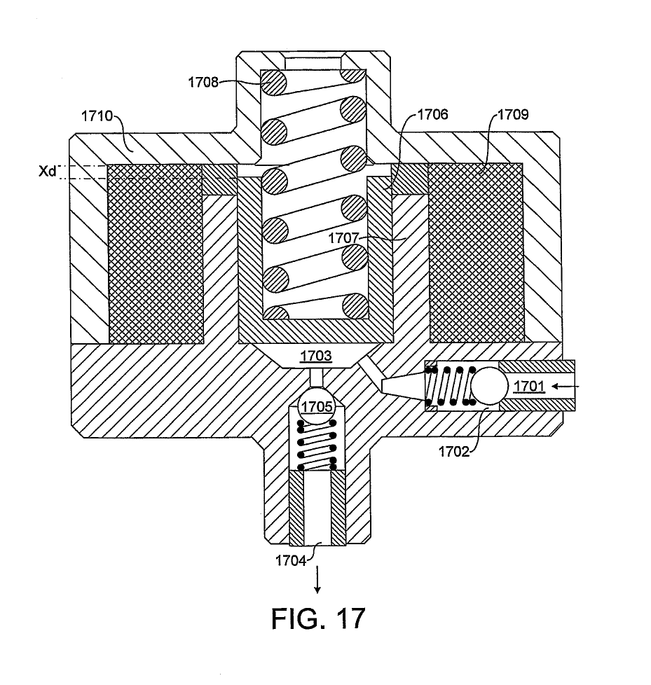

FIG. 17 shows a cross-section through a fuel injector suitable for use with the mixing tube of FIG. 12;

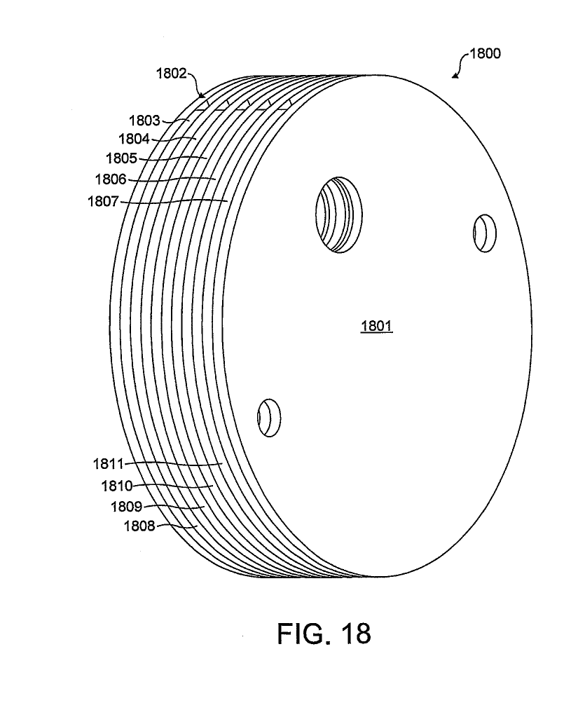

FIG. 18 is a perspective view of a mixing chamber formed from a first set of stacked discs;

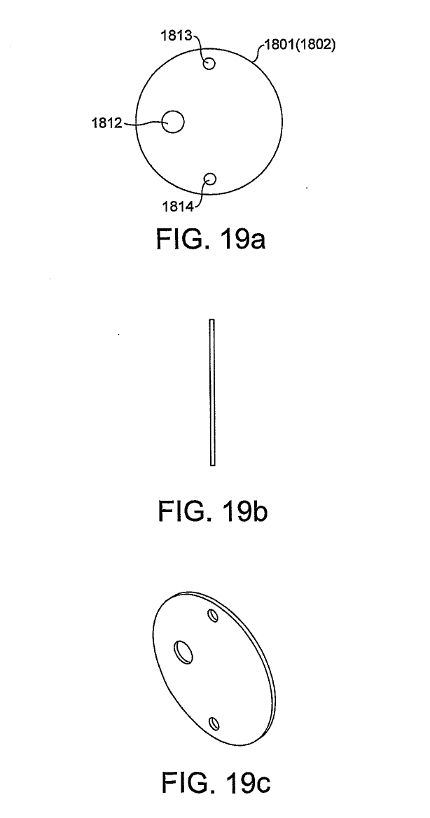

FIGS. 19a, 19b, and 19c show a disc of the type used for the top and bottom of the stack of FIG. 18;

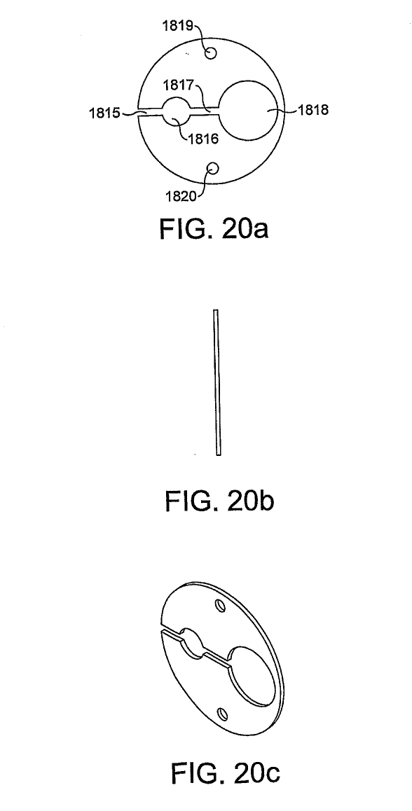

FIGS. 20a, 20b and 20c show a disc of the type used as an intermediate disc of the stack of FIG. 18;

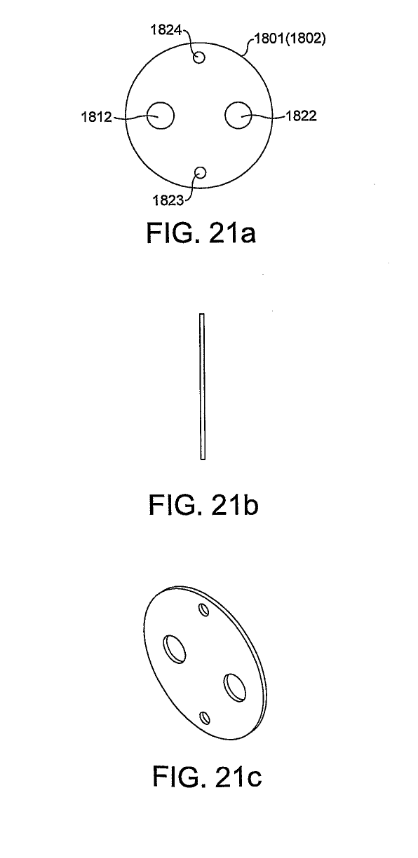

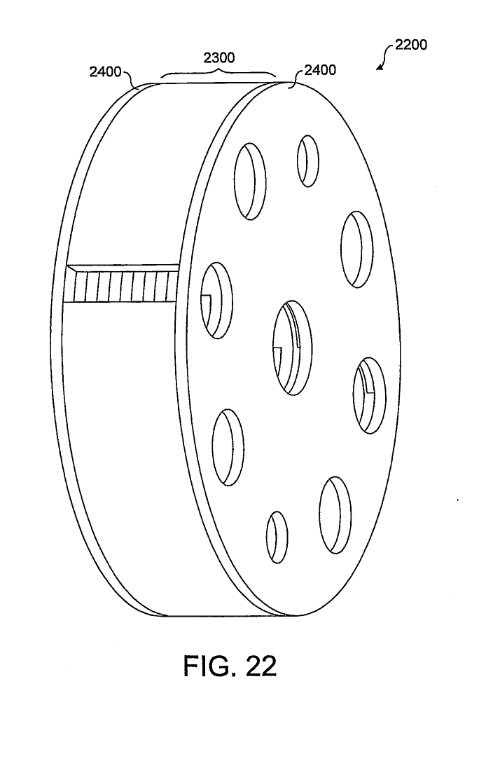

FIGS. 21a, 21b and 21c show a disc of the typed used as an intermediate disc of the stack of FIG. 18;

FIG. 22 is a perspective view of a mixing chamber formed from a second set of stacked discs;

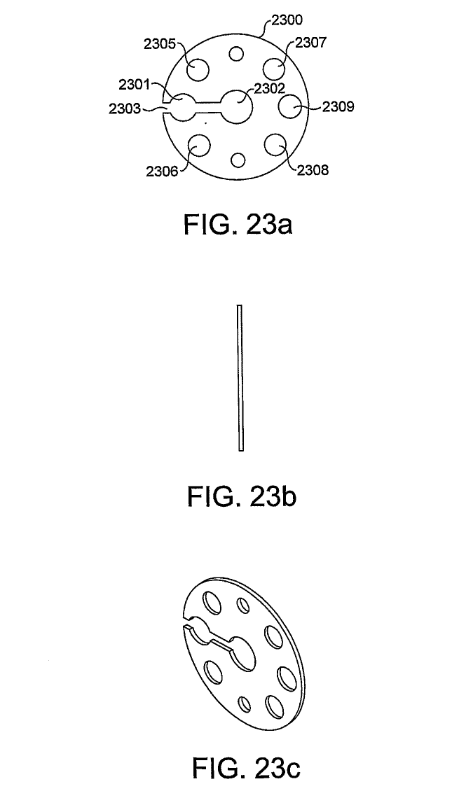

FIGS. 23a, 23b and 23c show a disc of the type used as an intermediate disc of the stack of FIG. 22; and

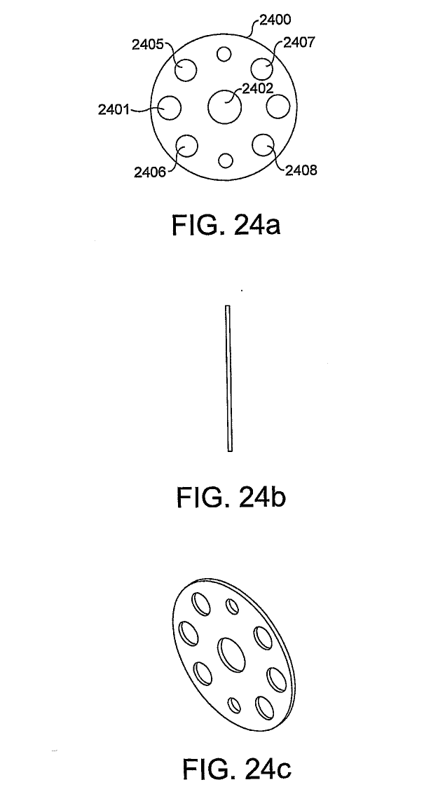

FIGS. 24a, 24b and 24c show a disc of the type used for the top and bottom discs of the stack of FIG. 22.

FIG. 1 shows an internal combustion engine having a variable volume combustion chamber 10 defined by a piston 11 reciprocating in a cylinder 12.

The piston 11 is connected by a connecting rod 13 to a crankshaft 14. A poppet valve 15 is an exhaust valve controlling flow of combusted gases out of the combustion chamber 10 to an exhaust passage 16. The valve 15 will be opened by a cam on a camshaft (not shown) which is connected to the crankshaft 14 to rotate with the crankshaft 14. The valve 15 will be closed by a valve spring (not shown) which biases the valve into abutment with its valve seat. A poppet valve 17 is an inlet valve controlling flow of fuel/air charge into the combustion chamber 10 from an inlet passage 18. The valve 17 will be opened by a cam on the aforementioned camshaft and closed by a valve spring (not shown).

The fuel injection system of the present invention comprises a fuel injector 20 of the type described in GB 2421543. The injector 20 is controlled by an engine control unit (ECU) 21 attached to a throttle body 22. An inlet butterfly throttle 23 is pivotally mounted in the throttle body 22 to throttle flow of air through the inlet passage 18. A sensor 24 will provide a signal indicative of throttle position to the ECU 21, which will also receive other signals such as a crankshaft position signal and/or a signal from a pressure sensor measuring air pressure in the inlet passage 18. The throttle body 22 incorporates a venturi 25, a narrowing in cross-sectional area of the inlet passage, which will induce a localised increase in flow velocity of air flowing through the inlet passage 18 and a consequent localised reduction in pressure. The injector 20 delivers fuel to a mixing tube 26 from which fuel is delivered via a fuel delivery nozzle 27 into the venturi 25, the fuel being entrained in air passing from a bypass passage 28 through the mixing tube 26 into the venturi 25. This will be described in more detail below.

FIG. 2 shows that the fuel injector 20 delivers fuel to a mixing chamber and accumulation volume 30 of the mixing tube 26. This is shown in greater detail in FIG. 5. The mixing tube 26 is located in a chamber 31 defined in the throttle body 22 and two rubber 0-rings 32,33 are provided between the mixing tube 26 and the surrounding chamber 31 to provide a fluid seal, respectively preventing flow of fuel along the exterior of nozzle 27 to the venturi 25 and flow of fuel past the injector 20. The inlet passage 28 opens on to the chamber 31 and delivers air to the chamber 31 from atmosphere, bypassing the throttle 23. As an alternative and as illustrated in FIG. 3, the bypass passage 28 can be connected to an exhaust gas recirculation passage 40 so that combusted gases can be delivered to the chamber 41 via the bypass passage 28. The hot combusted gases will aid fuel evaporation. A thermal barrier will be needed to prevent heat passing from the hot exhaust gases to the cool fuel supplied to the injector, but this can be achieved by careful positioning of passageways.

The mixing tube 26 is shown in detail in FIGS. 5, 6, 7, 8 and 9. The mixing tube 26 has four rows of four apertures; two rows 50, 51 are shown in FIG. 8. The apertures 60, 61, 62, 63 of row 40 are shown in FIG. 6. The apertures of the four rows allow flow of air from the chamber 31 into the mixing chamber 30. The rows 60, 61, 62, 63 are disposed at 90° intervals around a lower cylindrical wall 55 of the mixing tube. Three spaced rows 50, 51, 52 are shown in the cross-sectional view of FIG. 7 and all four rows 50, 51, 52, 53 in the cross-sectional view of FIG. 9. The fuel delivery nozzle 27 extends away from the lower part of the emulsion tube; the nozzle 27 is of a reduced diameter compared to wall 55 and an interior passage 59 in nozzle 27 is of a reduced diameter compared to chamber 30. A delivery aperture in the form of slot 90 is provided at a distal end of the nozzle 27 (distanced from chamber 30) via which fuel and air is delivered to the venturi 25. The slot 90 is elongate and aligned parallel with a central axis 91 of the nozzle 27.

Two pairs of aligned apertures are provided in the wall 55, spaced axially apart. One aperture 110 of a first pair and one aperture 111 of the second pair are shown in FIG. 7. These allow two bars 120, 121 to be located extending across the chamber 30 as can be seen in FIG. 9; the bars 120,121 extend at right angles to each other when viewed as seen in FIG. 9. The two bars 120, 121 are also seen in part in FIG. 5. When fuel is delivered by the injector 20 into the chamber 30 then the two bars 120, 121 prevent the fuel flowing immediately through the mixing chamber 30 and out of the nozzle 90 and instead ensure that the fuel accumulates in mixing chamber 30 for subsequent entrainment by air flowing through the bypass passage 28.

Operation of the fuel injection system is shown in FIGS. 4a to 4d. FIGS. 4a and 4b show operation at part throttle; the throttle 23 is rotated to partially close the inlet passage 18. FIG. 4a shows the condition when the inlet valve 17 is closed. While the valve is closed the injector 20 is used to deliver fuel into the mixing chamber 30, which fills up as illustrated (if desired the injector 20 could continue to inject fuel when the inlet valve 17 is open). The apertures of the four rows 50, 51, 52, 53 are sized such that surface tension of the fuel will prevent fuel flowing out of the mixing chamber 30 via the apertures. In FIG. 4b the intake valve 17 has been opened and air is drawn into the combustion chamber by downward motion of piston 11. The air is drawn through inlet passage 18 past throttle 23. A depression will be occasioned downstream of the throttle 23 by the air flow past the throttle 23. This will cause air to be drawn from the bypass passage 28 through the chamber 31 and via the emulsion tube 22 and out of the nozzle 27. The air drawn from the bypass passage 28 will entrain the fuel in the mixing chamber 30 as it flows through the emulsion tube 30. This will give rise to a mixture of fuel and air which is then delivered into the charge air in venturi 25 and is atomised in the air and the fuel/air charge is then delivered into the combustion chamber 10 for combustion.

FIGS. 4c and 4D show operation at full load: the throttle 23 is rotated to a wide open condition. FIG. 4c shows the condition when the inlet valve 17 is closed. Whilst the valve 17 is closed, the injector 20 delivers fuel to the chamber 30 of the emulsion tube, which fills as illustrated (the injector could continue to deliver fuel when the inlet valve 17 is open). Then at 4d the inlet valve 17 has opened and the piston 11 draws air into the combustion chamber 10 via the intake passage 17. Since the throttle 23 is wide open it offers little resistance to air flow and so does not itself give rise to a depression in pressure downstream of the throttle 23. Instead a fast flow of air through the intake passage 18 at high engine speeds/loads gives rise to a drop in pressure in the venturi 25. This drop in pressure draws air from the bypass passage 28 into the intake passage 18 via the mixing tube 26 and delivery nozzle 27. The air passing through the mixing tube 26 entrains the fuel in the mixing chamber 30 and delivers the fuel to the intake passage 18. The air passing through mixing chamber 30 forms an emulsion and gives rise to good atomisation of the fuel delivered to the intake passage 18 and hence to the combustion chamber 16.

The embodiment described, particularly with reference to FIG. 1, delivers gasoline fuel to a mixing chamber for mixing with air, e.g. in a four stroke engine. In a two-stroke engine it is necessary to mix both fuel and two-stroke lubricating oil with air, the mixture then typically being delivered to a crankcase and thereform via a transfer passage to a combustion chamber. FIG. 10 shows an arrangement of two injectors 9000 and 9001 which both deliver liquid into a mixing tube 9002 of the type already described prior to delivery via a nozzle 9003 into an intake passage 9004 downstream of a throttle valve 9005. A first injector 9000 delivers gasoline fuel to a mixing chamber 9005 in the mixing tube 9002. A second injector 9001 delivers two-stroke lubricating oil into the mixing chamber 9005. As can be seen in FIG. 10, the injector 9000 is immersed in gasoline 9006 provided in a gasoline reservoir 9007 which is connected via a pipe 9008 to a fuel supply line (not shown) connected to a fuel tank (again not shown)—fuel will flow from the fuel tank to the gasoline reservoir by gravity feed or pumped by a small fuel pump, e.g. a diaphragm pump driven by the vacuum cyclically induced downstream of the throttle 9005. It will also be seen that the second injector 9001 is immersed in two-stroke lubricating oil 9008 in a lubricating oil reservoir 9009, which is connected by a pipe 9010 to a lubricating oil supply line (not shown) connected to an oil tank (again not shown)—oil will flow from the fuel tank to the lubricating oil reservoir 9009 by gravity feed or pumped by a small oil pump, e.g. a diaphragm pump driven by the vacuum cyclically induced downstream of the throttle 9005.

The lubricating oil and fuel delivered to the mixing chamber 9005 by injectors 9000 and 9001 is entrained by bypass air flowing through a bypass passage 9011, in the manner described above. The mixture of fuel, oil and air delivered by the nozzle 9003 is mixed with the charge air flowing in intake passage 9004 and delivered to a crankcase 9012, from where it is delivered to a combustion chamber 9013 via a transfer passage 9014 (reciprocation of piston 9015 cyclically draws a fresh charge of fuel, air and oil into the crankcase 9012 and then expels the mixture from the crankcase 9012). A valve 9016 prevents the mixture of fuel, air and oil in crankcase 9012 flowing back to the throttle 9005 rather than through the transfer passage 9014.

The delivery of both oil and fuel into the mixing chamber gives a better efficiency of lubrication than existing systems which inject lubricating oil directly into an intake air passage to be picked up from the walls thereof by the fuel/air charge downstream of the carburettor. The atomisation and mixing of the oil ensures that it is more evenly dispersed in the charge air and better wets the parts requiring less lubricating oil, which results in cleaner emissions from the engine. The amount of oil dispensed can be carefully controlled by controlling the number of operations of the injector 9001 per engine cycle (or over a number of engine cycles) in response to engine demand. Thus the oil consumption and emissions of the engine are improved in comparison to a standard two-stroke engine which has oil injected directly into the intake passage downstream of the carburettor, to be picked up from the walls by the air intake. The present invention pre-mixes the oil with air prior to delivery into the charge air.

Whilst vaporisation of gasoline is a problem and the injector 9000 is ideally cooled or shielded from heat sources in the engine, vaporisation of two-stroke lubrication oil is not a problem and indeed some heating of the oil can be of benefit. No vapour control mechanism is needed to the two-stroke lubricating oil.

The embodiments described above have injectors 20, 9000 arranged to deliver gasoline fuel vertically upwardly into a venturi 25. However, it may be desired to arrange a gasoline injector to deliver fuel vertically downwardly or laterally into the venturi 25. The designs previously described must be modified to prevent fuel flowing under gravity out of the mixing chamber of the mixing tube. One possible modification is shown in FIG. 11, in which the injector 1020 is oriented to deliver fuel vertically downwardly into a chamber 1030 of a mixing tube 2026; the fuel is shown at 1031. The mixing tube 1026 comprises an inner tube 1010 and an outer tube 1011. The fuel 1031 fills an annular cavity defined between the tubes 1010 and 1011. Rows of apertures are provided in both tubes 1010 and 1011. The apertures are sized (as described above) such that surface tension of the fuel will prevent the fuel flowing through the apertures until entrained by air flowing through the bypass passage. The inner and outer tubes 1010, 1011 are co-axial. The inner tube 1010 extends vertically downwardly through an aperture in the outer tube 1011. The inner tube 1010 provides a delivery nozzle 1027 which extends vertically downwardly into a venturi 25 and has an orifice 1090 via which fuel is dispensed when entrained in air. For a two-stroke engine an injector of two-stroke lubricating oil could also be provided to inject lubricating oil into the mixing chamber 1030.

Recent work on fuel atomisation has indicated to the applicant that use of a mixing tube gives better results than sonic atomisation. Although the introduction of a mixing tube means that the air flow does not reach sonic velocities, the less restricted airflow has been found to better entrain the delivered fuel.

Instead of using two bars in a mixing tube as described above, a perforated plate or other baffle could be used.

The mixing tube could be made of brass or stainless steel both of which are corrosion resistant and are easy to machine. It is also possible that the mixing tube could be injection moulded in plastic, but the heat of EGR may cause problems for this.

When the engine is idling or on start-up the air flow is slow and the mixing tube can give very good atomisation in these circumstances, e.g. from when the engine is first cranked over. In most conventional engines, fuel is delivered onto the back of the intake valve(s) and then as the intake valve(s) open(s) the initially small annular clearance provides a restricted path for fuel/air flow which aids atomisation (the heat of the intake valve also aiding atomisation). However, in small engines (e.g. started by a hand pull mechanism) then there is not a high starting speed and there will be no heat on start up and so injecting fuel in such a conventional manner gives very poor mixing of fuel and air. The present invention permits use of a special regime on start up. In the start-up regime, all the airflow will be through the bypass passage 28 (the throttle valve 23 will be closed) and there will thus be maximum atomisation of the fuel and also the atomised fuel is delivered straight to the combustion chamber 10 without residence time in the cold intake passage.

In an alternative start-up strategy, a second start up valve is provided in the air intake passage in addition to the throttle. The start up valve will either completely close the air intake passage or will open the passage fully. On starting of the engine the start up valve will be closed so that all the intake air is drawn through the bypass passage. The start up valve will be opened once the engine has started.

The air intake passage need not be completely closed on start up; the passage could be mostly closed instead, by either or both of the throttle valve or the start up valve. The majority of the air supplied to the combustion chamber would still be supplied via the bypass passage, but a minority would flow past the throttle. This can be advantageous for larger capacity engines and also can be advantageous when the bypass passage is connected to the exhaust system to receive recycled combusted gases.

Above the fuel delivery nozzle 27 has been illustrated with a single delivery aperture 90. However, the performance of the apparatus could be improved by configuring the nozzle with a plurality of apertures—this is shown in FIGS. 12 and 13. FIG. 11 shows a row of vertically spaced apart apertures 6000, 6001, 6002, 6003 and 6004 provided on the downstream facing side of the fuel delivery nozzle 27. FIG. 13 shows that a plurality of such rows, numbered 6010, 6011, 6012 and 6013 are provided in the downstream side of the nozzle 27. The arrows in the FIGS. 11 and 12 indicate the direction of the airflow past the nozzle 27.

Above the embodiments have used a mixing tube as emulsion apparatus, but the applicant envisages that alternative apparatus could be used and examples are given in FIGS. 14 and 15.

In FIG. 14 a fuel injector 7000 of the type described previously delivers fuel upwardly into a mixing chamber 7001 defined between two plates 7002 and 7003 provided in a chamber 7004 defined in a throttle body 7005. The plates each have a plurality of apertures which allow a flow of air from a bypass passage 7006 into the mixing chamber 7001 and then a flow of fuel and air mixture out of the mixing chamber 7001 via a delivery nozzle 7007 into a venturi 7008 in the air flow passage. The nozzle 7007 is an aperture in the throttle body wall rather than a tube extending into the venturi 7008. The apertures in the plates 7002 and 7003 are sized such that liquid fuel delivered to and then resident in the mixing chamber 7001 will not flow out of the mixing chamber in the absence of a bypass air flow, due to surface tension. The plate 7003 does not have any apertures aligned with an outlet of injector 7000, in order that fuel delivered to the chamber 7001 under pressure by the injector 7000 does not flow directly out of nozzle 7007. Instead plate 7003 ensures that the injected fuel remains in the mixing chamber 7001 until entrained in a flow of bypass air.

FIG. 15 shows an arrangement similar to FIG. 14, except in the FIG. 15 embodiment only one apertured plate 8000 is used, rather than two plates, and in FIG. 15 fuel in injected downwardly into a mixing chamber 8001 by an injector 8002 and then delivered downwardly via nozzle 8003 into venturi 8004. Gravity will hold liquid fuel on the upstream surface plate 8000 until there is a flow of bypass air through passage 8005. Like in FIG. 13, the plate 8000 does not have apertures aligned with the outlet of injector 8002.

The present invention could use any fuel and air mixing apparatus which comprises a mixing chamber into which fuel is delivered by a fuel injector for subsequent mixing with bypass gas flow to form a mixture of fuel and gas for subsequent delivery to a combustion chamber.

The good atomisation provided by use of mixing chambers also allows the use of alternative fuels such as kerosene and diesel and also blended fuels (e.g. with ethanol). Two different injectors could be used to inject two different fuels with a common mixing chamber, e.g. gasoline and ethanol, for pre mixing together and with air prior to delivery into charge air in an intake passage.

In the embodiments described the fuel injection system is conveniently provided in the form of a unit detachable from the engine, the unit comprising: the throttle body 22 having the throttle 23 mounted therein and the bypass passage 28 and bypass chamber 31 integrally formed therein; the mixing tube 26 located in the bypass chamber 31; and the fuel injector 20 and associated electronics 21 provided as a unit attached to the throttle body 22. This eases repair/replacement and also facilitates incorporation of the fuel injection system in existing engine designs.

FIG. 16 shows a fuel injector 1600 suitable for use in the fuel injector system of FIGS. 1, 2 to 5 and 10, as any or all of the injectors 20, 9000 or 9001. The injector 1600 comprises a fuel inlet 1601 with a one-way inlet valve 1602 controlling flow of fuel from the fuel inlet 1601 into a variable volume pumping chamber 1603. The fuel injector also comprises a fuel outlet 1610 via which fuel is dispensed from the injector with a one-way outlet valve 1611 provided in the outlet. A piston 1604 is slidable in a housing 1605 to define with the housing 1605 the variable volume pumping chamber 1603. A spring 1606 biases the piston 1604 to a position in which the chamber 1603 has its smallest volume. An electrical coil 1607 surrounds the piston 1604 and can generate a field acting to draw the piston downwardly, as shown in the Figure, to a position on which the chamber 1607 has its greatest volume. The piston 1604 is movable between two end stops 1608 and 1609 which define a fixed travel distance Xd for the piston and thus a fixed swept volume. In each and every operation of the injector 1600 the set distance Xd is transversed so that a set constant unvarying volume is dispensed from the chamber 1603. The total volume of fuel delivered to an engine in each operating cycle is not altered by a changing the volume dispersed in each operation of the injector, but by solely controlling the number of operations of the injector per engine cycle.

In each operation of the injector the piston 1604 moves under action of the field generated by the coil 1601 to draw fuel (or lubricating oil) into the pumping chamber 1603 from the inlet 1601 via the one-way inlet valve 1602. The piston 1604 eventually hits the end stop 1609 and the induction of fuel (or lubricant) is completed. Then the applied field is switched off and the piston 1608 under action of spring 1606 moves to expel fuel (or lubricant) from the pumping chamber 1603 out of the outlet 1610 via the one-way outlet valve 1611. The one-way inlet valve 1602 prevents expulsion of fuel (or lubricant) from the pumping chamber 1603 to inlet 1601 and similarly the one-way outlet valve 1611 prevents fuel or lubricant being drawn into the chamber 1603 from the outlet 1610.

FIG. 17 shows the injector of FIG. 16 inverted for operation in the arrangement of FIG. 12. In FIG. 17 there can be seen: a fuel inlet 1701; a one-way inlet valve 1702; a pumping chamber 1703; a fuel outlet 1704; a one-way outlet valve 1705; a piston 1706 reciprocating in a cylinder 1707; a biasing spring 1708; and an electrical coil 1709 with an associated back iron 1710. The injector works in the same way as the FIG. 16 injector, but delivers liquid downwardly rather than upwardly.

The pumping chambers 1607 and 1703 are both frusto-conical in shape to improve flow of fluid therefrom to the outlet 1610, 1704.

FIGS. 18 to 21c show a further variant of mixing chamber 1800, usable in place of the mixing tube 26 of any of FIGS. 1 to 5, formed from a plurality of stacked discs. An end view of a completed stack 1800 is shown in FIG. 18, formed from a plurality of stacked discs comprising two end plates 1801 and 1802 sandwiching a plurality of intermediate discs 1803-1807 of a first type and 1808-1811 of a second type. Each disc 1803-1806 is sandwiched between either two discs 1808-1811 of the second type or between one disc 1808-1811 of the second type and an end plate 1801, 1802.

FIGS. 19a, 19b and 19c show one of the end plates 1801, 1802 (both are identical to each other). The plate 1802 shown is a circular disc having an aperture 1812 which functions either as a fuel inlet or fuel outlet and a pair of locating holes 1813, 1814 which allow the plate to be stacked on posts or secured by bolts.

FIGS. 20a, 20b and 20c show one of the intermediate plates of the plurality 1803-1807. This has a first slot 1815 which connects a first circular aperture 1816 to the exterior of the disc and a second slot 1817 which connects the first aperture 1817 with a second larger circular aperture 1818. The slot 1815 provides an air inlet for the stack, as can be seen in FIG. 18. It is sized so that surface tension of the fuel (or lubricant) prevents the fuel flowing out of the slot 1815. The plate also has a pair of locating holes 1819, 1820 which allow the plate to be stacked on posts or secured by bolts.

FIGS. 21a, 21b and 21c show one of the intermediate plates of the plurality 1808-1811. This has two circular apertures 1821, 1822 of equal size which in use will align with the apertures 1816 and 1818 of an abutting adjacent plate of the plurality 1803-1807. Also two locating holes 1823 and 1824 are provided which allow the plate to be stacked on posts or secured by bolts.

When the plates are all assembled then two channels are formed. One is formed by aligned apertures 1816 of the plates 1803-1807 and the apertures 1821 of plates 1808-1811 aligned therewith; this is open at the bottom of the stack to receive fuel from an injector via an aperture 1812 in an end plate at the bottom of the stack. The other is formed by aligned apertures 1818 of the plates 1803-1807 and the apertures 1822 of plates 1808-1811 aligned therewith. This passage is open to the exterior of the stack via an aperture 1812 in an end plate at the top of the stack and a mixture of fuel and air can be delivered via this passage to the outside of the stack.

In use the stack will receive fuel in the passage formed in part by the apertures 1816. This will initially be prevented from flowing through the slots 1815 and 1817 by surface tension. Then bypass air will flow through the slots 1815, entrain fuel in the passage defined in part by apertures 1811 and the fuel/air mixture will be delivered via slots 1817 to the passage formed in part by apertures 1818, from where it will be delivered e.g. through a nozzle into the charge air in the intake passage.

The choice of diameters for apertures 1821 and 1822 which differ from those of apertures 1816 and 1818 is deliberate to promote mixing of the fuel with the air by encouraging a turbulent flow. Also a greater surface area is presented to the flow of fuel and air which means that there is a greater heat transfer. The stack of plates is advantageously thermally coupled to the injector associated therewith so that the heat is transferred from the injector to flow of fuel and air, advantageously heating the fuel/air mixture to encourage vaporisation and advantageously cooling the injector to limit unwanted vaporisation of the fuel in the injector. In this regard the stack of plates will be mounted close to the injector to maximise heat transfer.

FIGS. 22, 23a to 23c and 24a to 24c show a variant on the idea of stacked plates. The stack 2200 of FIG. 22 is formed with plates 2300 as shown in FIGS. 23a to 23c, sandwiched between two end plates 2400 as shown in FIGS. 24a to 24c. The plates 2300 are stacked one on top of the other without interposition of the plates 2400, with the orientation of one plate 2300 reversed in relation to the plate 2300 below and/or above, so that an aperture 2309 of one plate is aligned with an aperture 2303 in a plate immediately above or below. Two passages for receiving fuel or lubricant are thus formed, both of which communicate with a central passage for delivering of a mixture of air with fuel and/or lubricant—for instance one passage could receive fuel and the other lubricant, or one passage receive gasoline and the other ethanol. Slits 2303 allow bypass air to flow from outside the stack to each passage and slits 2304 then allow fuel or lubricant mixed with air to flow onwards to the central passage defined by apertures 2302. The slits 2303 and 2304 are sized to prevent flow of fuel or lubricant out of a passage in the absence of flow of air—the surface tension of the fuel or lubricant preventing this.

The discs 2300 are also provided with flow apertures 2305-2308 which align with flow apertures 2405-2408 in the discs 2400 and provide flow passages for fuel. Fuel can flow through these passages to the fuel injector and be cooled by heat transfer with the fuel and air mixture flowing from the stack—the fuel evaporating in the fuel/air mixture will have a cooling effect. The fuel supplied to the fuel injector is advantageously cooled in order to limit vaporisation.

1. An internal combustion engine comprising:
a variable volume combustion chamber;
an air intake passage supplying air to the combustion chamber via an air intake valve;
a throttle provided in the air intake passage for throttling flow of air through the air intake passage;
a venture formed in the air intake passage downstream of the throttle;
a bypass passage which bypasses the throttle and via which air and/or recirculated exhaust gas is supplied to the venture of the intake passage via, a delivery outlet located in a throat of the venturi;
a fuel injector;
fuel and air mixing means comprising a bypass flow chamber, connected to the bypass passage, surrounding a mixing chamber, the mixing chamber being enclosed within the bypass flow chamber and arranged such that the fuel can accumulate in and fill up the mixing chamber for subsequent entrainment; and
a control unit operatively associated with the injector and the intake valve to deliver fuel from the fuel injector to the mixing chamber while the air intake valve is closed;
wherein the bypass passage is connected to the fuel and air mixing means so that air or recirculated exhaust gas flowing through the bypass passage passes through the mixing chamber, entrains fuel present in the mixing chamber and a resulting mixture is delivered from the mixing chamber means to the intake passage via the delivery outlet.

2. An internal combustion engine as claimed in claim 1 wherein the mixing chamber is defined in part by a surface provided with a plurality of inlet apertures via which air/recirculated gas can be drawn into the mixing chamber from the bypass chamber, the inlet apertures being sized such that surface tension of the fuel will resist flow of fuel out of the mixing chamber via the inlet apertures to the bypass flow chamber.

3. An internal combustion engine as claimed in claim 1 wherein the mixing chamber is defined in part by a surface provided with a plurality of outlet apertures via which a mixture of fuel and air/recirculated gas can be drawn from the mixing chamber, the outlet apertures being sized such that surface tension of the fuel will resist flow of fuel out of the mixing chamber via the outlet apertures to the delivery outlet.

4. (canceled)

5. An internal combustion engine as claimed in claim 1, wherein a flow impediment is provided in the mixing chamber to prevent fuel injected by the fuel injector flowing straight through the mixing chamber to the fuel delivery outlet, whereby fuel delivered by the fuel injector can accumulate in the mixing chamber for subsequent entrainment in flow of bypass air or bypass recirculated gas.

6.-13. (canceled)

14. An internal combustion engine as claimed in claim 1 wherein:
the mixing chamber is defined at least in part between inner and outer tubes;
the outer tube is provided with the plurality of inlet apertures via which air/recirculated gas can be drawn into the mixing chamber from the mixing chamber and which are sized such that surface tension of the fuel will resist flow of fuel out of the mixing chamber to the bypass flow chamber; and
the inner tube is provided with a plurality of apertures via which fuel entrained in a flow of bypass air/recirculated gas can pass to the delivery outlet and which are sized such that surface tension of the fuel will resist flow of fuel out of the mixing chamber to the delivery nozzle in absence of a flow of bypass air/recirculated gas flow.

15. An internal combustion engine as claimed in claim 14 wherein the fuel injector delivers fuel vertically downwardly or laterally into the mixing chamber.

16. An internal combustion engine as claimed in claim 15 where the fuel delivery outlet is a nozzle which extends vertically downwardly or laterally into the air intake passage.

7. An internal combustion engine as claimed in claim 1 comprising a venturi in the air intake passage and wherein the delivery outlet delivers to the venturi, whereby any pressure drop occasioned by air flow through the venturi will draw air or recirculated gas from the bypass passage through the mixing chamber means.

18.-21. (canceled)

22. A method of operation of the internal combustion engine claimed in claim 1 in which on starting of the engine the throttle is fully closed so that all or nearly all of the air drawn into the combustion chamber is drawn through the bypass passage and via the mixing chamber means.

23. A method of operation of the internal combustion engine claimed in claim 1 in which on starting of the engine a start up valve is used to mostly or fully close the air intake passage so that all or nearly all of the air drawn into the combustion chamber is drawn through the bypass passage and via the mixing chamber.
